(19) United States
(12) Patent Application Publication
(10) Pub. No.: US 2007/0179984 A1
(43) Pub. Date: Aug. 2, 2007

(54) Information element processing method and apparatus

(75) Inventor: Isamu Watanabe, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/406,303

(22) Filed: Apr. 19, 2006

(30) Foreign Application Priority Data
Jan. 31, 2006 (JP) 2006-021780

(51) Int. Cl. G06F 17/30

(52) U.S. Cl. 707/200

(57) ABSTRACT

This invention is to generate an information element map where the associations between information elements of different types can be easily understood. For this purpose, the method includes: extracting a plurality of information elements from an information group; calculating a degree of each association between the extracted information elements; identifying an attribute of a relational line connecting the information elements to each other according to the degree of each association between the extracted information elements; identifying a category of each extracted information element; and updating at least one of the degree of the association between the extracted information elements and the attribute of the relational line according to the identified categories of the extracted information elements. This enables to figure out whether the information elements at both ends of the relational line are of the same type or of different types.

### TECHNICAL FIELD OF THE INVENTION

The present invention relates to a technique for searching or analyzing an information group such as text data.

### BACKGROUND OF THE INVENTION

In recent years, as storage mediums increase in capacity and drop in price and computer networks including the Internet spring into wide use, it becomes possible to easily collect and store a large amount of information by using a computer. In order to retrieve necessary information from the information group collected as described above, or carry out search or analysis to obtain some knowledge, there is an absolute need for a technique for searching or analyzing the information group in accordance with a user's request due to the huge quantity of the information.

As for the technique for searching or analyzing the information group, the following techniques currently predominate: a technique for selecting and displaying documents including an information element such as a word or a character string specified by a user, and a technique for classifying an information group according to the appearance frequency of an information element (a word, a phrase, or the like) or the like and presenting the classified information. Recently, however, an analytical technique using an information element map becomes available.

The information element map represents information elements extracted from an information group and relations between the information elements as an illustration, by which the structure of the entire information group can be overviewed intuitively. Therefore, the utilization of the information element map as an interface enables users to search information while embodying an obscure search request or to analyze the tendency or features of the entire information group.

Today, there are the following established techniques: a technique for extracting a word, a phrase, or other information elements from an input information group by using a morphological analysis or other methods, a technique for obtaining distance information between the information elements by calculating the degree of association between the information elements using statistical information concerning the appearance of the information elements, or the like. Once the distance information is obtained, it is possible to generate an information element map where highly associated information elements are arranged close to each other by applying a statistical analysis, multivariate analysis, visibility method or the like, which have conventionally been used for quantitative data.

A multi-dimensional space, however, is necessary to represent associated information, accurately. Therefore, generally the associated information between information elements has a distance structure in the multi-dimensional space. For this reason, the distance relation cannot be represented accurately on a two-dimensional plane. In consequence, it may lead to a discrepancy in the representation that information elements arranged close to each other on the information element map are not highly associated each other in practice.

Techniques to resolve the problem are described in “Text Mining Based on Keyword Association” (Isamu Watanabe and Kazuo Misue, IPSJ Special Interest Group on Fundamental Informatics (SIGFI) Book No. 55, Information Processing Society of Japan (IPSJ), pp. 57-64, July 1999) and “Visualization of Keyword Association for Text Mining” (Kazuo Misue and Watanabe Isamu, IPSJ Special Interest Group on Fundamental Informatics (SIGFI) Book No. 55, Information Processing Society of Japan (IPSJ), pp. 65-72, July 1999). Specifically, the aforementioned problem is resolved by arranging highly associated information elements so as to be close to each other using an automatic layout method and drawing relational lines between information elements. The strength of the association between the information elements is visualized by display attributes such as the thickness, line type, and color of the relational line. Therefore, even if there is an inconsistency in the positional relation, association information can be read correctly.

It should be noted, however, that a case where the associations between information elements shown in the information element map are easily grasped by the representation of the relational lines is limited to a case where the associations between the information elements are sparse, in other words, where there are associations only between limited information elements. When the associations are dense, in other words, in a case where there are associations between almost all the information elements, for example, as shown in FIG. 1, the relational lines are overlapped on the display and therefore it is hard to read association information between information elements from the visual information of the relational lines.

FIG. 1 shows an example of a map where the associations between information elements are dense, which have been generated using the techniques described in the aforementioned two articles.

The aforementioned two articles describe techniques for resolving the aforementioned problem. Specifically, as shown in FIG. 2, by changing the line type of relational lines whose association is low or hiding such relational lines, and displaying only the main skeletal association information, the associations between information elements shown in the information element map can be easily understood.

FIG. 2 shows an information element map represented in such a way that the associations between information elements can be easily understood by changing the line type of the relational lines or hiding the relational lines using the aforementioned techniques, for the same data as in FIG. 1.

A technique for facilitating the understanding of association information by changing display attributes of relational lines is also described, for example, in JP-A-2004-178270. More specifically, the method includes: a step of calculating alternate paths between a pair of nodes, which are formed of two or more connected edges, for each node as a starting point from a dataset indicating a connection relation between a plurality of nodes, and registering them into a list; and an emphasis processing step of carrying out at least one of limiting the edges between the pair of nodes or assigning weights according to the alternate paths between the pair of nodes.

The technology for generating an information element map by reducing association information according to the strength of the association, in other words, ignoring a portion of association information does not only relate to the issue of whether the relational lines should be displayed, but is also useful for the process of a layout calculation for determining the arrangement of information elements. The arrangement of information elements is determined by a hierarchical layout method described, for example, in “About Hierarchical Drawing Method of Compound Graph Aimed at Graphical-oriented Support” (Kazuo Misue and Kozo Sugiyama, Transactions of Information Processing Society of Japan, Information Processing Society of Japan, Vol. 30, No. 10, pp. 1324-pp. 1334, October 1989).

FIG. 3 shows an example where the arrangement of information elements is calculated by the hierarchical layout method described above for the same data as in FIG. 1.

Furthermore, it becomes possible to make the relation between information elements easily understood on the basis of the arrangement of the information elements as shown in FIG. 4 by reducing association information in the layout calculation for determining the arrangement of the information elements.

FIG. 4 shows an example of a map, which makes the association between information elements easily understood on the basis of the arrangement of the information elements by reducing association information whose association is low in accordance with the techniques described in the firstly cited two articles, for the same data as in FIG. 1.

A technique for facilitating the understanding of the associations between information elements shown in the information map by reducing association information is also described, for example, in JP-A-2004-21913. More specifically, the method includes: a limiting information acquiring step for acquiring limiting information for an information map; and an information map generation step of generating an information map in such a way that a plurality of elements represented in the information map are connected to other elements via relational lines on the basis of the limiting information.

Moreover, there is a case of identifying the type of information element when extracting the information element from an information group. For example, US 2006/0039607 A1 describes a technique for extracting feature information such as a keyword characterizing the content of an electronic document, accurately and cyclopaedically for each plurality of viewpoints, and ensuring independence of the respective viewpoints. More specifically, the feature information is extracted for each plurality of viewpoints from the electronic document, and as for the feature information extracted in a plurality of viewpoints, the score is calculated for each viewpoint, and then the viewpoint of the feature information extracted in the plurality of viewpoints is identified based on the calculated score. Moreover, for example, EP-0725332-A2 describes a technique for changing a display method according to attribute information of each node. Specifically, it describes means for storing attribute information of each node, means for retrieving a node satisfying a predetermined requirement according to the attribute information, and means for highlighting the node in a flow diagram.

As described above, in accordance with the conventional information element map generation techniques, it is possible to generate an information element map in which the associations between information elements can be understood more easily by using a technique for reducing association information according to the strength of the association. Although this technique is effective when the information element map includes only the information elements having the same type, however, it does not function very effectively when the information element map includes information elements having different types together, which are extracted using the technique described in JP-A-2005-326922. Even if information elements whose degree of association is low or whose importance is low are simply reduced as described in JP-A-2004-21913, it is impossible to facilitate the understanding of the degrees of associations between information elements of different types. Also, the technique described in JP-A-8-212254 only clarifies the attribute information of information elements in the information element map and does not facilitate the understanding of the associations between information elements of different types themselves.

### SUMMARY OF THE INVENTION

Therefore, an object of the present invention is to provide a new technique for generating an information element map where the associations between information elements of different types can be easily understood.

The information element processing method according to the present invention includes: extracting a plurality of information elements (for example, a word, a phrase, and other character strings) from an information group (for example, text information) and storing them into a storage device; calculating a degree of each association between the extracted information elements and storing it into the storage device; identifying an attribute of a relational line connecting the information elements to each other according to the degree of each association between the extracted information elements and storing it into the storage device; identifying a category of each extracted information element and storing it into the storage device; and updating at least one of the degree of the association between the extracted information elements and the attribute of the relational line according to the identified categories of the extracted information elements and storing updated data into the storage device.

In this method, the concept of a category of the information element is introduced in order to figure out whether the information elements at both ends of the relational line are of the same type or of different types. Moreover, when the information elements at both ends of the relational line belong to different categories, the degree of association or the attribute of the relational line is set differently from those of information elements belonging to the same category. Thereby, a user can easily understand the association between information elements of different types.

Moreover, the method may further include: calculating coordinates at which the extracted information elements are arranged, according to the degree of the association between the extracted information elements and storing them into the storage device. This enables data generation for arranging the information elements in appropriate positions in the information element map while taking into consideration the categories of the information elements.

For example, upon update of the category of information elements, the degree of the association between the relevant information elements is changed. By updating the arrangement of the information elements in the information element map accordingly, the latest condition can be presented to the user.

The aforementioned coordinates calculating may be executed when the degree of each association between the extracted information elements is updated in the updating. By doing so, it is also possible to update the arrangement of the information elements in the information element map according to the updating of the categories of the information elements.

In the aforementioned category identifying, the category of the information element may be identified by acquiring information representing a correspondence between the information element and the category.

Moreover, the method may further include: identifying at least one of the appearance positions of each information element and dependency information of each information element and storing it into the storage device. Then, in the aforementioned category identifying, the category of each information element may be identified according to at least one of the appearance position of each information element and the dependency information of each information element.

Moreover, in the aforementioned category identifying, the category of each information element may be identified according to character string information included in each information element.

Moreover, the method according to the present invention may further include: accepting a request for changing a category of an arbitrary information element among the plurality of information elements. Then, in the aforementioned category identifying, the category of the arbitrary information element may be changed according to the request. For example, even if a category identified by other methods is not appropriate, the user can achieve intended categorization.

Incidentally, in the present invention, the information group may be a patent document group and the information element may be at least one of bibliographic information of the patent document group and the word used in the patent document group.

It is possible to create a program for causing a computer to execute the information element processing method according to the present invention. The program is stored into a storage medium or a storage device such as, for example, a flexible disk, a CD-ROM, a magneto-optical disk, a semiconductor memory, or a hard disk. In addition, the program may be distributed as digital signals over a network in some cases. Data under processing is temporarily stored in the storage device such as a computer memory.

### BRIEF DESCRIPTION OF THE DRAWINGS

The above and other objects, features and advantages of the present invention will become apparent from the following detailed description when taken with the accompanying drawing in which:

FIG. 1 is a diagram showing an example of an information element map where the associations between information elements are dense, which has been generated using conventional techniques;

FIG. 2 is a diagram showing an example when changing the line types of relational lines or hiding relational lines in the information element map shown in FIG. 1;

FIG. 3 is a diagram showing an example when changing the arrangement of the information elements using the hierarchical layout method in the information element map shown in FIG. 1;

FIG. 4 is a diagram showing an example of changing the arrangement of the information elements by reducing association information in the information element map shown in FIG. 1;

FIG. 5 is a diagram showing an example of the information element map where different types of information elements exist, which has been generated using a conventional technique;

FIG. 6 is a diagram showing an example of a result where association information is reduced using a conventional technology in the information element map shown in FIG. 5;

FIG. 7 is a system schematic diagram according to an embodiment of the present invention;

FIG. 8 is a diagram showing a processing flow in the embodiment of the present invention;

FIG. 9 is a diagram showing an example of data stored in an information element storage before a category determination processing;

FIG. 10 is a diagram showing a processing flow of a category determination processing;

FIG. 11 is a diagram showing an example of data stored in a category definition table;

FIG. 12 is a diagram showing an example of data stored in a category identification information database;

FIG. 13 is a diagram showing an example of data stored in an association degree storage;

FIG. 14 is a diagram showing an example of data stored in the information element storage after calculating the degree of association and coordinates;

FIG. 15 is a diagram showing an example of an information element map generated according to the embodiment of the present invention;

FIG. 16 is a diagram showing a processing flow in the embodiment of the present invention;

FIG. 17 is a diagram showing an example where the category of an information element has been updated on the basis of a category change request in the information element map shown in FIG. 15;

FIG. 18 is a diagram showing a processing flow of a line type update processing;

FIG. 19 is a diagram showing a first example of the result of the line type update processing in the information element map shown in FIG. 15;

FIG. 20 is a diagram showing a second example of the result of the line type update processing in the information element map shown in FIG. 15;

FIG. 21 is a diagram showing a processing flow of a coordinate update processing;

FIG. 22 is a diagram showing an example of the result of the coordinate update processing in the information element map shown in FIG. 15; and

FIG. 23 is a functional block diagram of a computer.

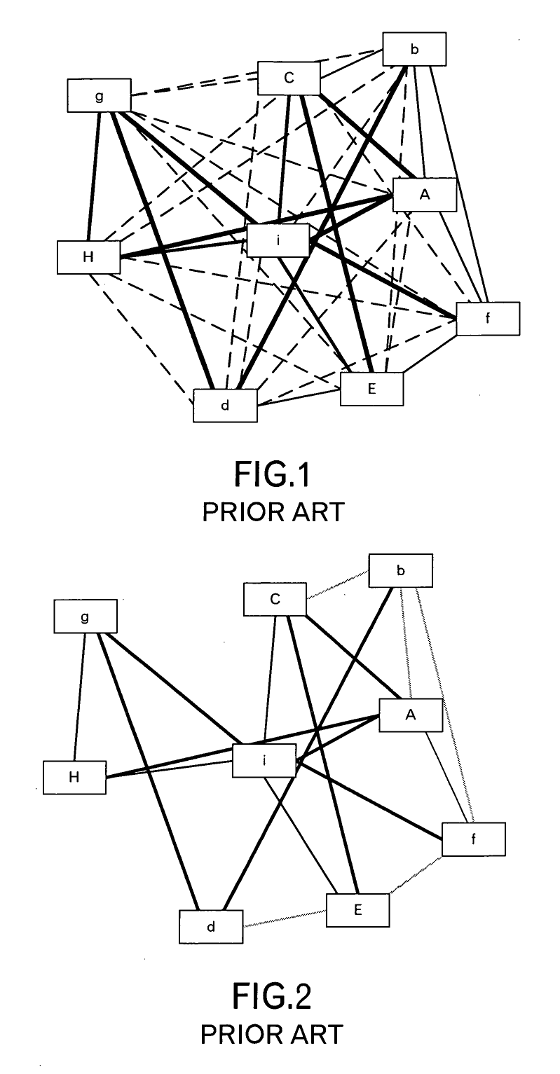

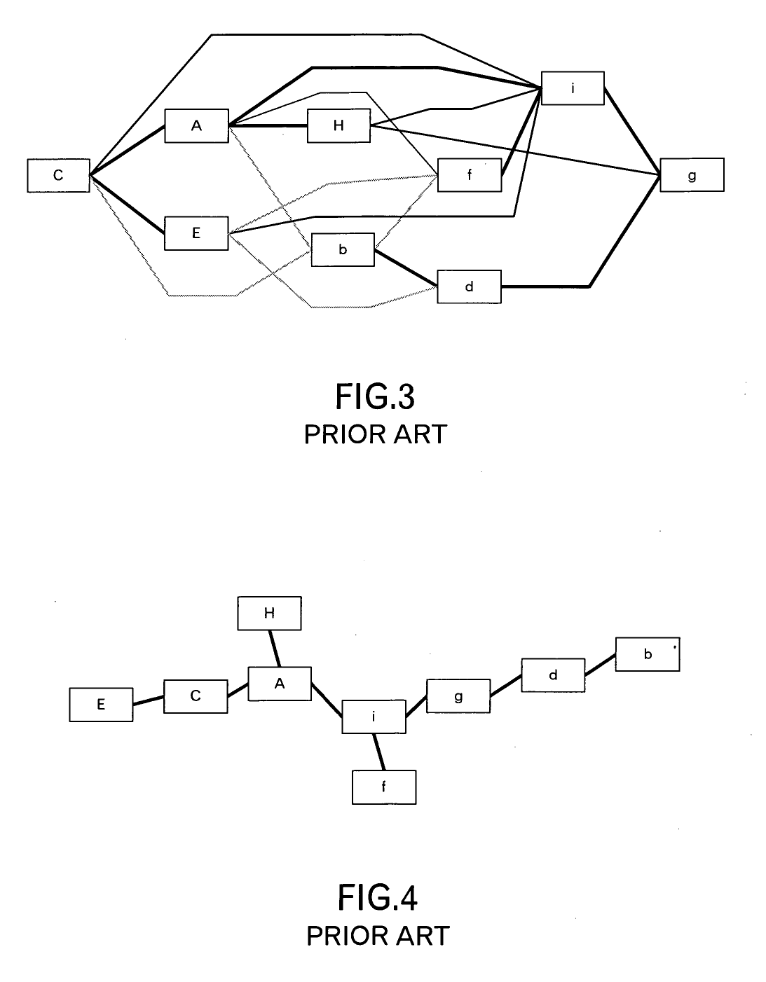

### DETAILED DESCRIPTION OF THE PREFERRED EMBODIMENTS

Before describing an embodiment of the present invention, a concrete example will be outlined first as a case of generating an information element map where different types of information elements coexist and analyzing associations between the different types of the information elements. For example, this section discusses a case of analyzing a correspondence between “object” and “means” in an information element map containing information elements representing “object”, namely information elements belonging to a category “object” and information elements representing “means”, namely information element belonging to a category “means.” More specifically, for example, patent documents including a keyword such as a word “engine” are assumed to be an information group to be searched. As described above, the information element is a word or a phrase including a plurality of words extracted by a morphological analysis, which is a conventional technique. For example, a phrase that includes a series of nouns like “rotation control means” is treated as an information element, not in units of a word, but in units of a phrase. Furthermore, for patent documents, an application number, an applicant, an inventor or the like may be treated as an information element in some cases.

In this case, the following three types of associations are assumed as association information between information elements:
(1) Association connecting one “object” to another “object”
(2) Association connecting one “means” to another “means”
(3) Association connecting “object” with “means”

When aiming at analyzing the correspondence between “object” and “means,” particularly the association (3) is significant among the aforementioned three types of association information. Therefore, it is preferable to determine the attributes of relational lines between information elements or the arrangement of the information elements in such a way that the user can easily understand the association (3). For example, it is conceivable to reduce association information as described above.

In the conventional technique, however, the association information is reduced only on the basis of the strength of the association and therefore the association information cannot be reduced by distinguishing the types of association information. Therefore, the association (1) or the association (2) can be given priority over others, whereby the association (3) may not be displayed as a relational line or may not be used for the layout calculation.

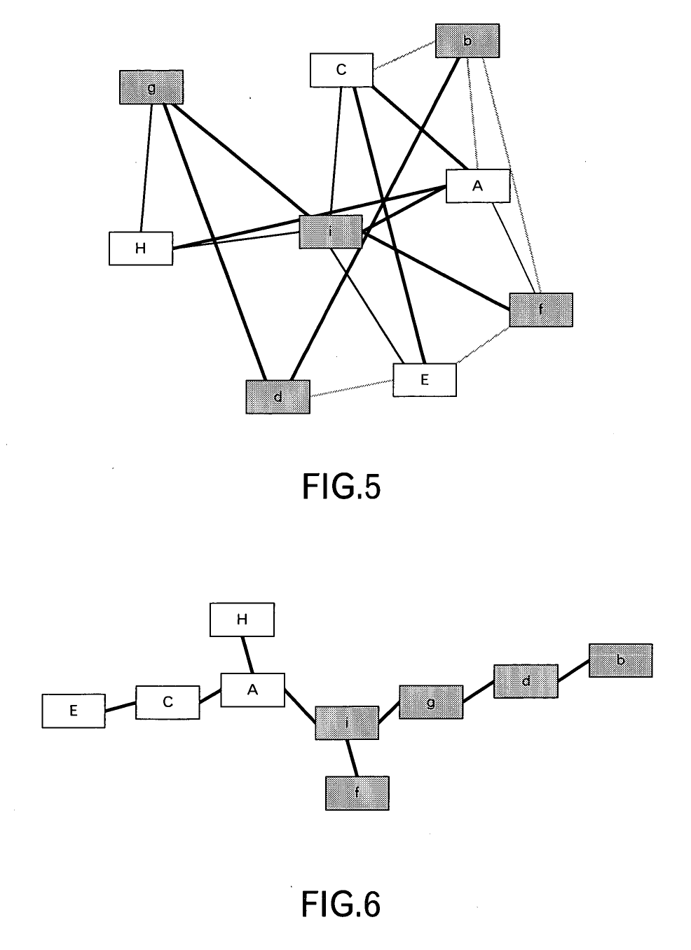

FIG. 5 shows an example of an information element map where different types of information elements exist, and FIG. 6 shows a result where association information is reduced using the conventional technique for the information element map shown in FIG. 5. In both figures, A, C, E, and H correspond to information elements belonging to the category “object” and b, d, f, g, and i correspond to information elements belonging to the category “means.” More specifically, there is shown an example where the information element A is a word “lightweighting,” the information element b is a phrase “rotation control means,” the information element C is a word “mileage,” the information element d is a phrase “electronic control unit,” the information element E is a phrase “manufacturing cost,” the information element f is a phrase “intake valve,” and the information element i is a word “aluminum.”

In this example, the association (1) or the association (2) is stronger than the association (3). Therefore, most of the associations (3) are deleted and the correspondence between “object” and “means” cannot be read out in an appropriate manner. For example, the degree of association between the means “rotation control means” and the means “electronic control unit” is greater than the degree of association between the means “rotation control means” and “lightweighting” or “mileage” that is the object of using the rotation control means. Therefore, the relational line between the “means” such as the rotation control means and the “object” of using the rotation control means is not displayed in the information element map where the associations between information elements whose degree of the association is low are reduced as shown in FIG. 6.

On the other hand, by carrying out the processing described below, it is possible to generate an information element map where a user can easily understand the association (3) described above.

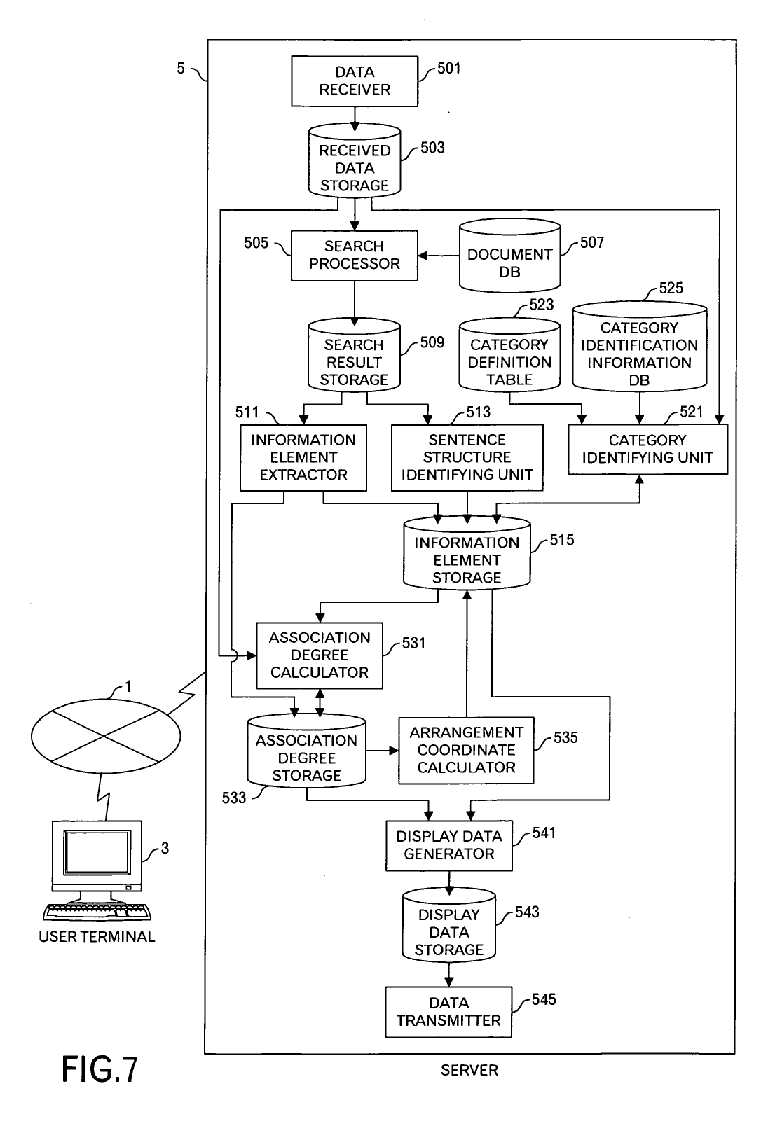

FIG. 7 shows a system outline according to the embodiment of the present invention. A user terminal 3 and a server 5 are connected to a network 1 such as, for example, an in-house local area network (LAN). The user terminal 3 has, for example, a web browser function to access the server 5 over the network 1. Although the following describes an example of a client-server configuration including the user terminal 3 and the server 5, it may be a standalone configuration where all functions of the server 5 are implemented in the user terminal 3.

As shown in FIG. 7, the server 5 includes a data receiver 501, a received data storage 503, a search processor 505, a document database 507, a search result storage 509, an information element extractor 511, a sentence structure identifying unit 513, an information element storage 515, a category identifying unit 521, a category definition table 523, a category identification information database 525, a association degree calculator 531, a association degree storage 533, an arrangement coordinate calculator 535, a display data generator 541, a display data storage 543, and a data transmitter 545.

The data receiver 501 receives data from the user terminal 3 and stores it into the received data storage 503. The search processor 505 carries out a processing with reference to the received data storage 503 and the document database 507 and stores the processing result into the search result storage 509. The information element extractor 511 carries out a processing with reference to the search result storage 509 and stores the processing result into the information element storage 515 and the association degree storage 533. The sentence structure identifying unit 513 carries out a processing with reference to the search result storage 509 and stores the processing result into the information element storage 515. The category identifying unit 521 carries out a processing with reference to the received data storage 503, the information element storage 515, the category definition table 523, and the category identification information database 525, and stores the processing result into the information element storage 515. The association degree calculator 531 carries out a processing with reference to the received data storage 503, the information element storage 515, and the association degree storage 533 and stores the processing result into the association degree storage 533. The arrangement coordinate calculator 535 carries out a processing with reference to the association degree storage 533 and stores the processing result into the information element storage 515. The display data generator 541 carries out a processing with reference to the information element storage 515 and the association degree storage 533 and stores the processing result into the display data storage 543. The data transmitter 545 extracts data from the display data storage 543 and transmits the data to the user terminal 3.

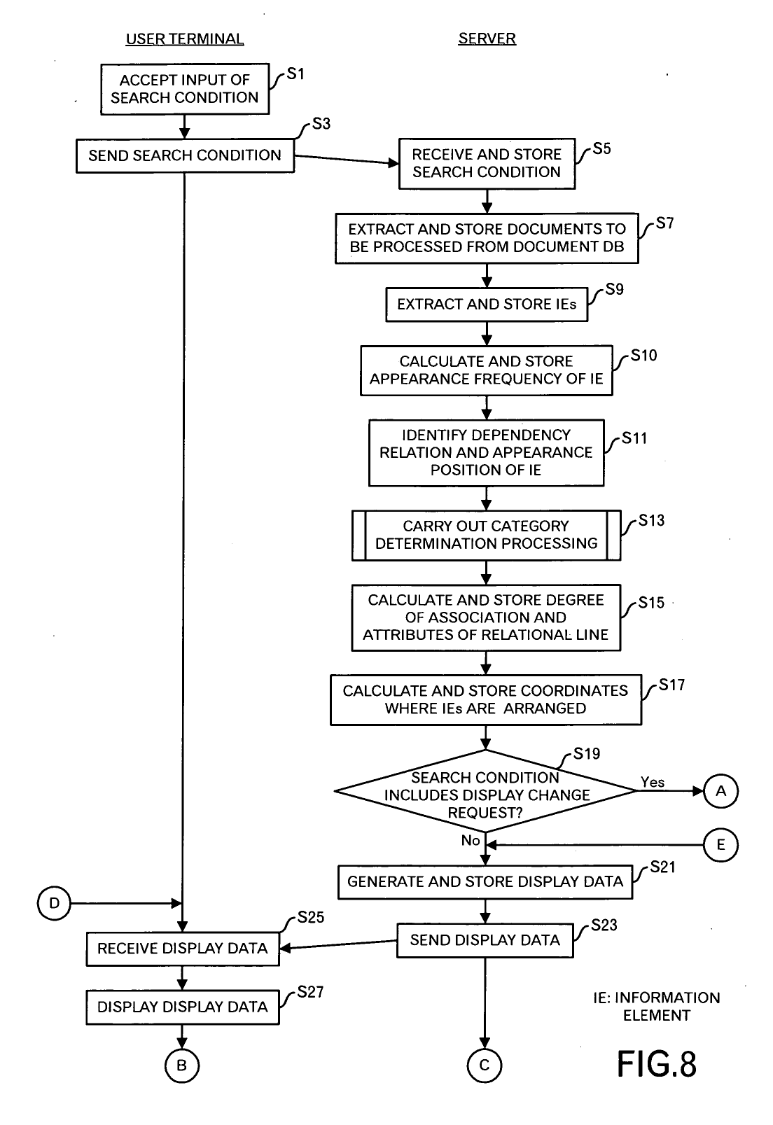

Subsequently, a processing in this embodiment will be described by using FIG. 8 to FIG. 22. Hereinafter, an example is indicated to generate an information element map by classifying information elements extracted from the patent document into information elements belonging to the category “object” and information elements belonging to the category “means” in the same manner as in the example described above.

Incidentally, it is assumed that the user terminal 3 accesses the server 5 using a client program (for example, a web browser or a dedicated client program) and that the display device of the user terminal 3 displays a search condition input screen. A user of the user terminal 3 enters a necessary search condition on the search condition input screen. The search condition is used for narrowing down an information group from which the information elements are to be extracted when generating the information element map. For example, when the information group includes patent documents, the search condition may include a filing date, a patent classification, an applicant, a keyword included in the specification or the like. Incidentally, the search condition may include a display change request, which is described in the following.

In response to this, the user terminal 3 accepts the input of the search condition from the user (step S1) and transmits the search condition data to the server 5 (step S3). The data receiver 501 of the server 5 receives the search condition data from the user terminal 3 and stores it into the received data storage 503 (step S5). The search processor 505 searches the document database 507 according to the search condition data stored in the received data storage 503, reads out the documents conforming to the search condition, and stores them into the search result storage 509 (step S7).

The information element extractor 511 reads out the document data stored in the search result storage 509, extracts information elements from the documents, and stores them into the information element storage 515 (step S9). In the following, it is assumed that the information elements A, b, C, d, E, f, g, H, and i (the difference between capital letter and small letter indicates a difference in category). Because the information elements as words or phrases can be extracted by a known language analysis technique such as a morphological analysis and therefore the detailed description is omitted here.

Moreover, the information element extractor 511 reads out the document data stored in the search result storage 509, counts the appearance frequencies of the extracted information elements, and stores the count values into the information element storage 515 (step S10). When the search result storage 509 stores data of a plurality of documents, the information element extractor 511 counts the appearance frequencies for each document and stores the count values into the information element storage 515.

Subsequently, the sentence structure identifying unit 513 reads out the document data stored in the search result storage 509, identifies a dependency relation of the extracted information element and its appearance position in the document, and stores them into the information element storage 515 (step S11). The dependency relation of the information element is, for example, a relation between a modifier and a modificand. More specifically, it is information on, for example, the roles of the information element in a context such as “X improves C” or “improve Y by d.” In addition, the appearance position in the document is information representing a paragraph or section where the information element appears in the document. In the patent document, the appearance position of the information element in the document can be identified by a header name such as, for example, “means for solving problem” or “problem to be solved by the invention.” The dependency relation and the appearance position in the document can be identified by a known dependency analysis and a document structure analysis processing. Therefore, their detailed description is omitted here.

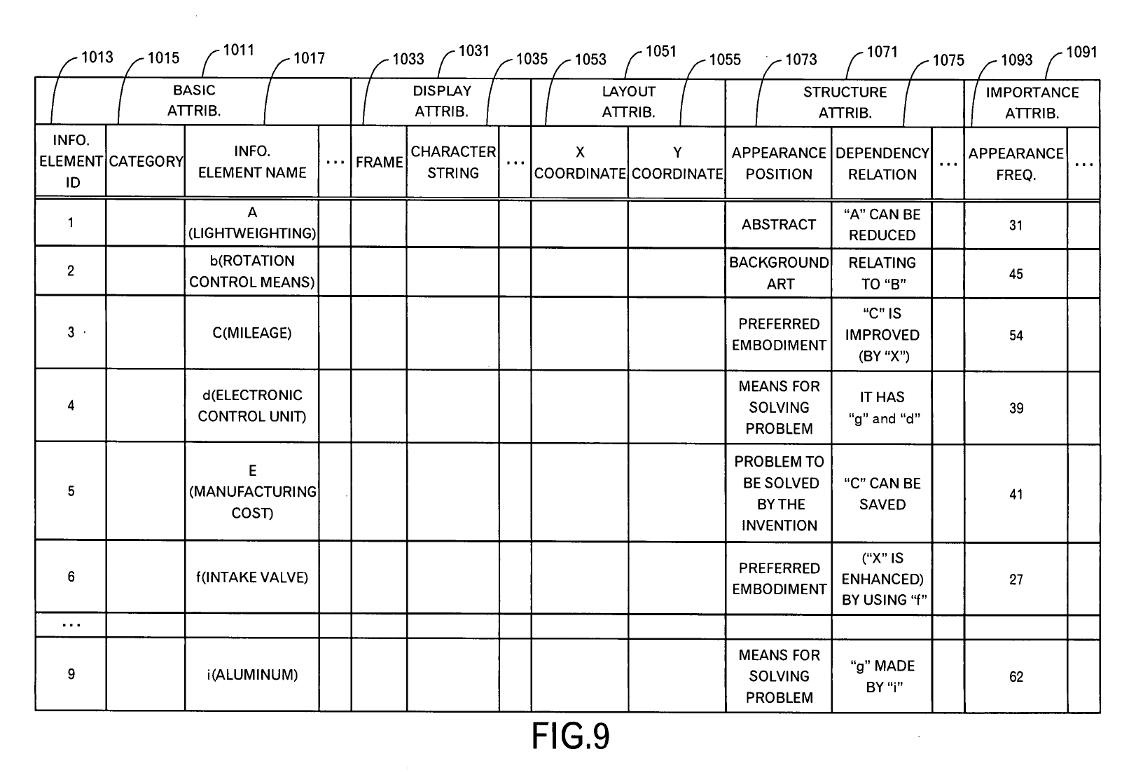

FIG. 9 shows an example of data stored in the information element storage 515. In the example shown in FIG. 9, the information element storage 515 stores a table for storing data for use in a later processing, and the table includes a basic part 1011, a display attribute part 1031, a layout attribute part 1051, a structure attribute part 1071, and an importance attribute part 1091. The basic part 1011 includes an information element ID column 1013, a category column 1015, and an information element name column 1017. The display attribute part 1031 includes a frame column 1033 and a character string column 1035. The layout attribute part 1051 includes an X-coordinate column 1053 and a Y-coordinate column 1055. The structure attribute part 1071 includes an appearance position column 1073 and a dependency relation column 1075. The importance attribute part 1091 includes an appearance frequency column 1093. The information element ID column 1013 stores identification information uniquely set for each information element.

The information element name column 1017 stores the information elements A to i extracted in the step S9. The appearance position column 1073 and the dependency relation column 1075 store the appearance position of the information element in the document and the dependency relation of the information element extracted in the step S11, respectively. The information stored in the appearance position column 1073 and the dependency relation column 1075 is used for a category determination processing described later. Although the dependency relation column 1075 shows the expressions for facilitating the understanding of the concept in FIG. 9, practically data “dependency source,” “dependency destination,” “dependency attribute” and the like are registered. Incidentally, a plurality of dependency relations may be registered for one information element. Similarly, a plurality of appearance positions may be registered for one information element. The appearance frequency column 1093 stores appearance frequencies of the information elements extracted in the step S10. The importance attribute part 1091 may further include a column, for example, for storing appearance frequencies in a specific paragraph or section in the patent document, in addition to the appearance frequency column 1093. It is because in some cases the degree of association can be calculated more accurately by reducing the unit of calculating the appearance frequency, for example, as described in “5.2 Analytical Example 2” of “Text Mining through Associative Relation between Words” (Isamu Watanabe and Kazuo Misue, IPSJ Special Interest Group on Fundamental Informatics (SIGFI) Book No. 55, Information Processing Society of Japan (IPSJ), pp. 57-64, July 1999). In the step S11, data is not set yet in other columns.

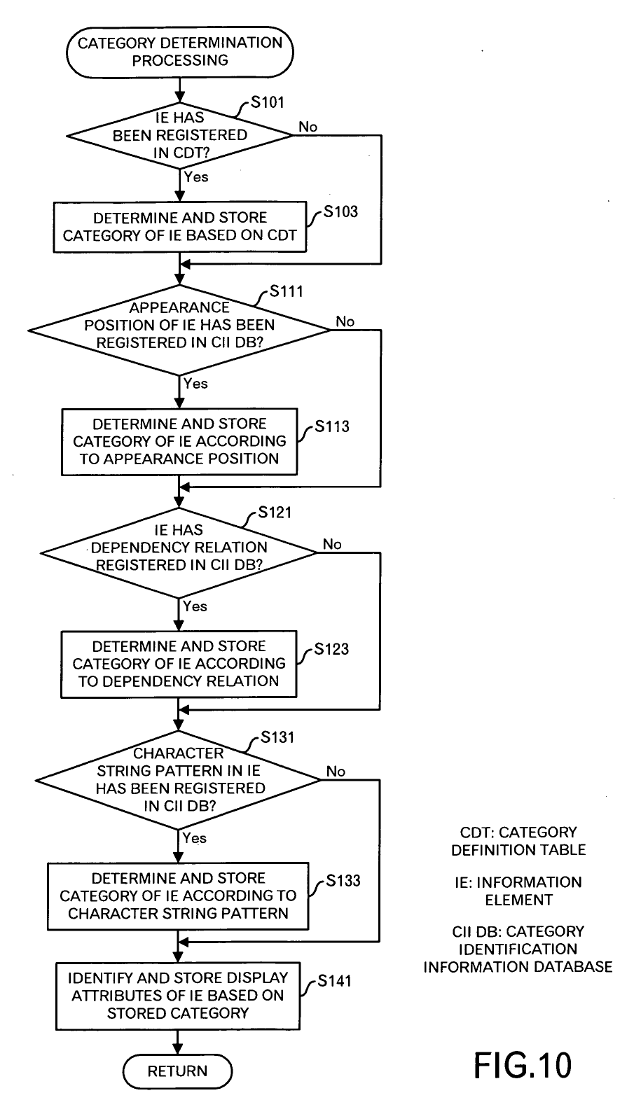

Returning to the description of the processing shown in FIG. 8, the category identifying unit 521 carries out a category determination processing (step S13). An example is described to allocate one of the categories “object” and “means” to each of the extracted information elements. The details of the category determination processing will be described by using FIG. 10. The category identifying unit 521 checks whether the information element is registered in the category definition table 523 with reference to the information element storage 515 and the category definition table 523 (step S101). When the information element is registered (step S101: YES route), the category identifying unit 521 determines the category of the information element on the basis of the category definition table 523 and stores it into the information element storage 515 (step S103). On the other hand, when the information element is not registered in the category definition table 523, the processing progresses to step S111 (step S101: NO route).

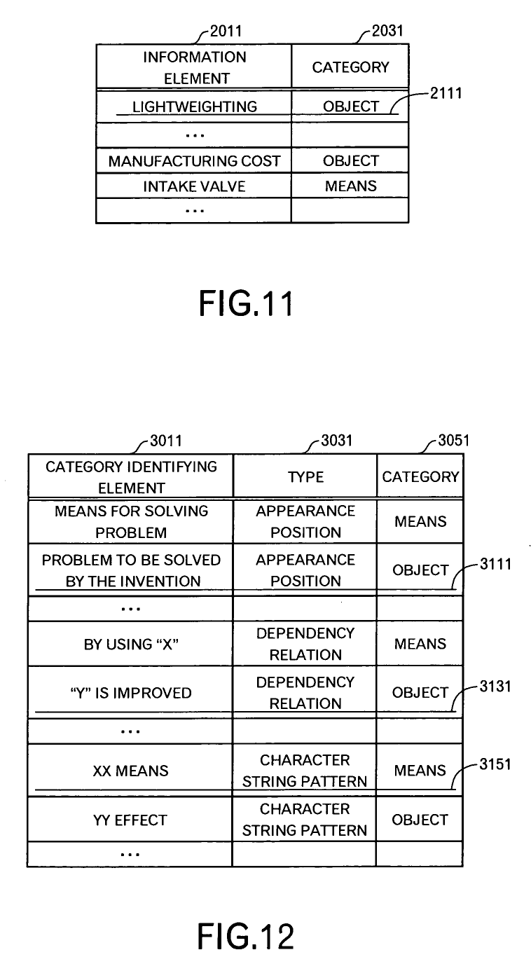

FIG. 11 shows an example of data stored in the category definition table 523. The category definition table 523 includes an information element column 2011 and a category column 2031. As shown in a row 2111 of FIG. 11, the category definition table 523 stores, for example, a word “lightweighting” with being associated with the category “object” and the information element storage 515 stores the information element A as “lightweighting.” Therefore, the information element A can be identified as belonging to the category “object.” Similarly, the category definition table 523 stores data for the information elements E and f with being associated with the categories.

Returning to the description of the processing in FIG. 10, the category identifying unit 521 checks whether the appearance position of the information element stored in the information element storage 515 is registered in the category identification information database 525 with reference to the information element storage 515 and the category identification information database 525 (step S111). When the appearance position of the information element is registered in the category identification information database 525 (step S111: YES route), the category identifying unit 521 determines the category of the information element according to the appearance position of the information element and stores it into the information element storage 515 (step S113). On the other hand, when the appearance position of the information element is not registered in the category identification information database 525, the processing progresses to step S121 (step S111: NO route).

FIG. 12 shows an example of data stored in the category identification information database 525. The category identification information database 525 stores a table prepared for data for use in determining the categories of the information elements as shown in FIG. 12. The table includes a category identifying element column 3011, a type column 3031, and a category column 3051. Here, as shown in a row 3111 of FIG. 12, a category identifying element “problem to be solved by the invention” is registered in the category identification information database 525 with being associated with a type “appearance position” and a category “object.” On the other hand, the information element storage 515 stores information that the appearance position of the information element E is “problem to be solved by the invention.” Therefore, the category of the information element E can be identified as “object.” Similarly, the category of the information element d and i can also be identified by using the category identification information database 525.

Returning to the description of the processing shown in FIG. 10, the category identifying unit 521 checks whether the dependency relation of the information element stored in the information element storage 515 is registered in the category identification information database 525 with reference to the information element storage 515 and the category identification information database 525 (step S121). When the dependency relation is registered in the category identification information database 525 (step S121: YES route), the category identifying unit 521 determines the category of the information element, which corresponds to the dependency relation, according to the category identification information database 525 and stores it into the information element storage 515 (step S123). On the other hand, when the dependency relation of the information element is not registered in the category identification information database 525, the processing progresses to step S131 (step S121: NO route).

As shown in a row 3131 of FIG. 12, a category identifying element representing the dependency relation such as “Y is improved” is registered in the category identification information database 525 with being associated with a type “dependency relation” and a category “object.” On the other hand, the information element storage 515 stores the information that the information element C has a dependency relation such as “C is improved by X.” Thereby, the category of the information element C can be identified as “object.” Similarly, the category of the information element f can be identified by using the category identification information database 525.

Subsequently, the category identifying unit 521 checks whether the information element stored in the information element storage 515 includes a specific character string pattern registered in the. category identification information database 525 with reference to information element storage 515 and the category identification information database 525 (step S131). When the information element includes the specific character string pattern (step S131: YES route), the category identifying unit 521 determines the category of the information element, which corresponds to the character string pattern, according to the category identification information database 525 and stores it into the information element storage 515 (step S133). On the other hand, when the information element does not include the specific character string pattern registered in the category identification information database 525, the processing progresses to step S141 (step S131: NO route).

As shown in a row 3151 of FIG. 12, a category identification element “XX means” is registered in the category identification information database 525 with being associated with a type “character string pattern” and a category “means.” Furthermore, the information element storage 515 stores information that the information element b is “rotation control means.” Therefore, the category of the information element b can be identified as “means” because the information element b includes the character string pattern “XX means.”

Then, the category identifying unit 521 specifies display attributes of each information element according to the category of the information element determined in the aforementioned processing and stores it into the information element storage 515 (step S141). For example, the category identifying unit 521 specifies display attributes such as black characters in a black frame for the information element belonging to the category “object” and specifies display attributes such as white characters in a blue frame for the information element belonging to the category “means.” In some cases, it may specify the display attributes of an information element belonging to a specific category in such a way as to hide the information element on the information element map. Incidentally, the display attributes of the information element may be specified in a processing of calculating the degree of association or a processing of calculating the coordinates described below. In addition, the server 5 may further have a table storing the correspondence between the category of an information element and the display attributes of the information element and may specify the display attributes of the information element on the basis of the table.

As a result of carrying out the aforementioned category determination processing for all extracted information elements, the information elements A, C, E, and H are identified as belonging to the category “object” and the information elements b, d, f, g, and i are identified as belonging to the category “means” and then the corresponding categories are stored into the information element storage 515. In the category determination processing, a plurality of categories may be allocated to a certain information element. For example, there is a case where an information element is determined to fall under the category “object” on the basis of dependency information, while it is determined to fall under the category “means” on the basis of the appearance position information. In this case, the information element may be determined so as to belong to one of the categories by the method described, for example, in US 2006/0039607 A1. Instead of automatically determining one category, a user may designate the category. Moreover, the steps S101 to S103, steps S111 to S113, steps S121 to S123, and steps S131 to 133 may be carried out in parallel or may be carried out in a different order. Moreover, the category is not limited to the contents of the information elements such as “object” and “means” as described above, but can be bibliographic items such as, for example, the name of applicant or a patent classification. Although not described in the FIG. 10, the category determination processing is carried out for each of all the extracted information elements.

Returning to the description of the processing shown in FIG. 8, the association degree calculator 531 calculates the degree of association between information elements by using the appearance frequencies stored in the information element storage 515 and stores it into the association degree storage 533. The processing of calculating the degree of association is the same as conventional. For example, there is a well-known vector space model using the TF/IDF method, the Kullback-Leibler method, or the like. In addition, the association degree calculator 531 determines the attributes of a relational line between the information elements on the basis of the degree of association stored in the association degree storage 533 and the categories of the information elements stored in the information element storage 515 and stores them into the association degree storage 533 (step S15). As for the attributes of the relational line between the information elements, the association degree calculator 531 determines, for example, a thickness according to a value of the degree of association and determines a color and a line type according to whether the both end information elements belong to the same category. As for the thickness, according to preset data including the threshold value for each level of the thickness, the association degree calculator 531 determines the thickness by comparing the degree of association with the threshold values. In addition, the attributes of the relational line between the information elements maybe determined on the basis of, for example, a table that stores the correspondence between the degree of association between the information elements, the category of the both end information elements, and the attributes of the relational line between the information elements.

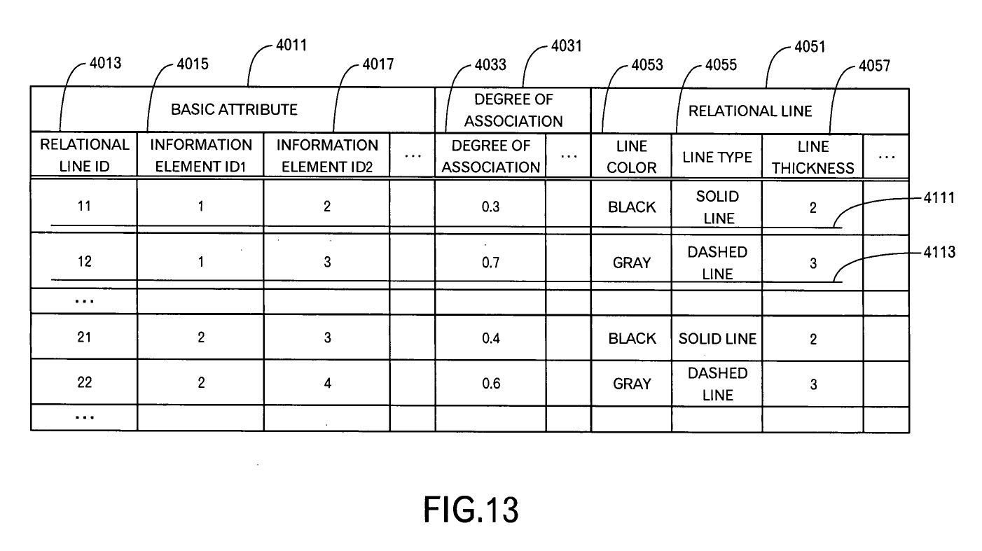

FIG. 13 shows an example of data stored in the association degree storage 533. In the example shown in FIG. 13, the association degree storage 533 stores a table for storing the degree of association between information elements and the attributes of the relational lines between the information elements. The table includes a basic attribute part 4011, a degree-of-association part 4031, and a relational line part 4051. The basic attribute part 4011 includes a relational line ID column 4013, an information element ID1 column 4015, and an information element ID2 column 4017. The degree-of-association part 4031 includes a degree-of-association column 4033. The relational line part 4051 includes a line color column 4053, a line type column 4055, and a line thickness column 4057. The relational line ID column 4013 stores identification information uniquely set for each relational line between the information elements. The information element ID1 column 4015 and the information element ID2 column 4017 store the information element IDs of the information elements at both ends of the relational line. The degree-of-relation column 4033 stores the degree of association between the information elements calculated in the step S15. The line color column 4053, the line type column 4055, and the line thickness column 4057 store the attributes of the relational line between the information elements determined in the step S15.

In this embodiment, the degree of association between the information elements stored in the degree-of-association column 4033 is the same as the degree of association between the information elements in the conventional technique. The processing of updating the degree of association according to a change in category (for example, a processing of decreasing the degree of association between the information elements belonging to the same category) will be described later. On the other hand, when determining the attributes of the relational line, consideration is also given to the categories in addition to the strength of the association, and therefore the attributes of the relational line differ according to whether the information elements are of different categories or of the same category. For example, as shown in rows 4111 and 4113 of FIG. 13, the attributes of the relational line between the information elements belonging to different categories include a black solid line and the attributes of the relational line between the information elements belonging to the same category include a gray dashed line.

Returning to the description of the processing of FIG. 8, the arrangement coordinate calculator 535 calculates coordinates to arrange the information elements on the information element map with reference to the association degree storage 533 and stores them into the information element storage 515 (step S17). The processing for calculating the coordinates is the same as conventional: for example, the processing described in the article referenced in the Background Art may be carried out. Incidentally, the coordinates of the information elements are expediently determined in order to represent each distance between the information elements obtained based on the degree of association between the information elements on a two-dimensional plane.

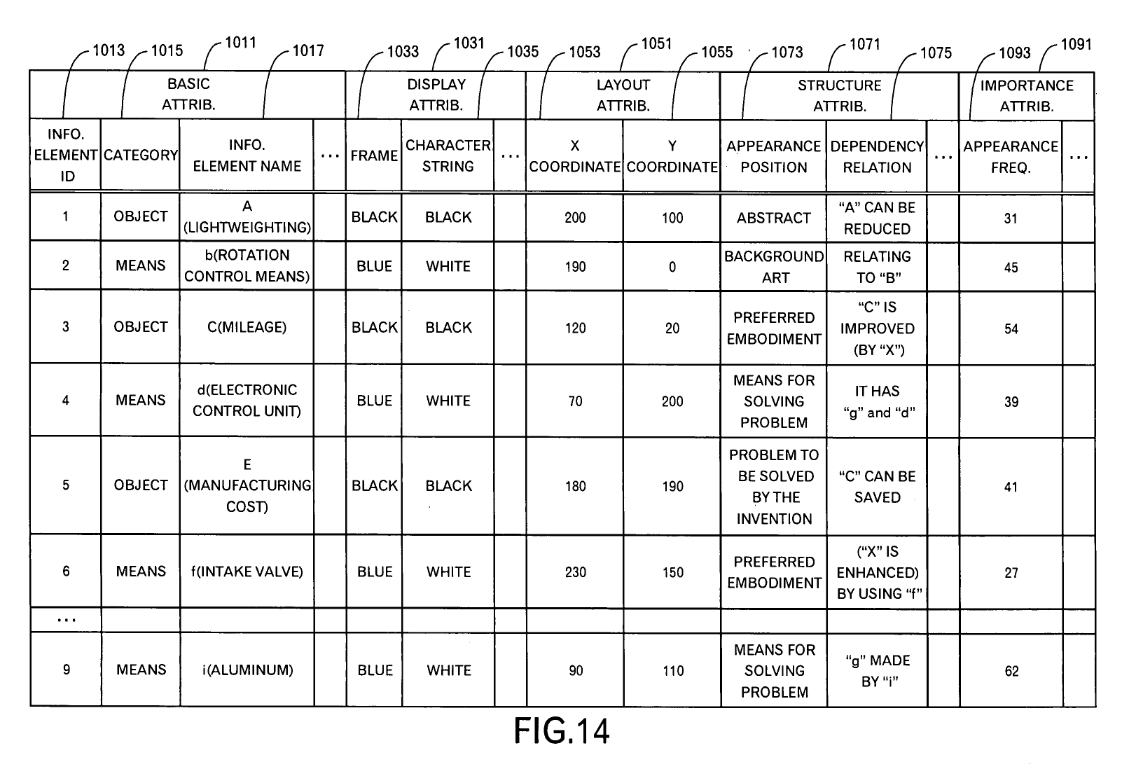

FIG. 14 shows an example of data stored in the information element storage 515 after calculating the degree of association and the coordinates. The category column 1015 stores the categories of the information elements determined in the step S13. The category identifying unit 521 stores the display attributes of the information elements specified in the step S141 into the frame column 1033 and the character string column 1035. Here, the display attributes of black characters in a black frame are specified for the information element belonging to the category “object” and the display attributes of white characters in a blue frame are specified for the information element belonging to the category “means.” The X coordinate column 1053 and the Y coordinate column 1055 store the coordinates of the information elements calculated in the step S17. In the example shown in FIG. 14, the degree of association between the information elements is calculated according to the conventional technique and therefore the coordinates of the information elements are the same as the coordinates of the information elements in the information element map (for example, FIG. 5) generated by using the conventional technique.

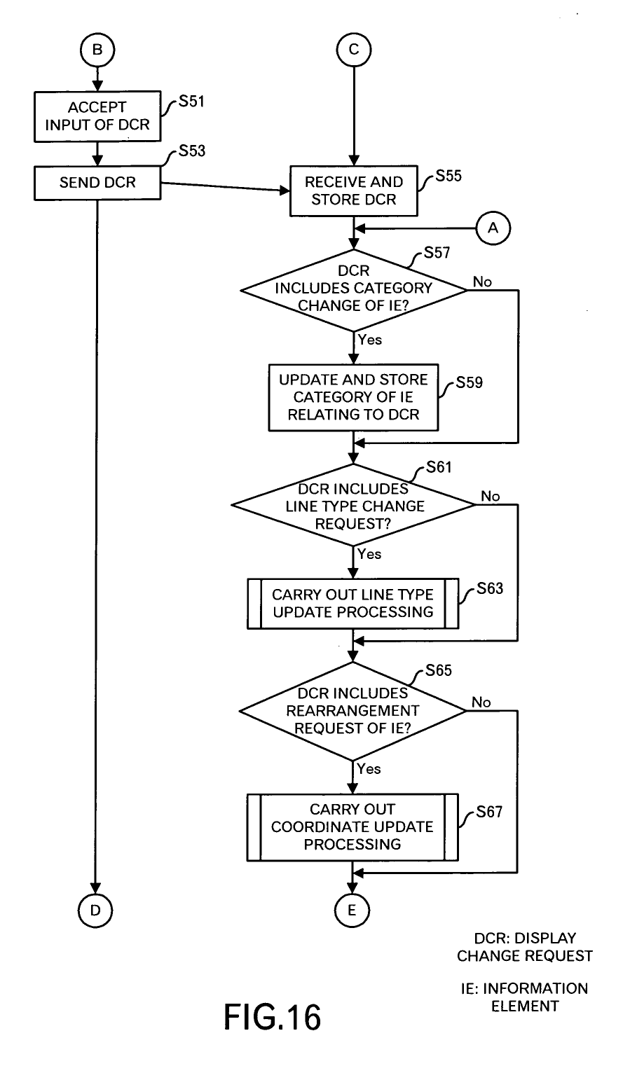

Returning to the description of the processing shown in FIG. 8, the association degree calculator 531 judges whether the search condition received from the user includes a display change request with reference to the received data storage 503 (step S19). When the search condition is determined to include the display change request here (step S19: YES route), the processing progresses to a processing flow of FIG. 16 via a terminal A. The display change request and the processing in the processing flow of FIG. 16 will be described later. On the other hand, when the search condition is not determined to include the display change request (step S19: NO route), the processing progresses to step S21.

Subsequently, the display data generator 541 generates data to display the information element map with reference to the information element storage 515 and the association degree storage 533 and stores it into the display data storage 543 (step S21). The processing of generating data to display the information element map is the same as conventional and therefore the description is omitted here.

Incidentally, when using a dedicated client program, the information elements to be displayed, their coordinate data and display attributes, and the attributes of the relational line between the information elements may be transmitted to the client program, so that the client program generates display data in some cases.

The data transmitter 545 reads out the data to display the information element map from the display data storage 543 and transmits it to the user terminal 3 (step S23). The processing progresses to the processing flow shown in FIG. 16 via a terminal C.

The user terminal 3 receives data to display the information element map from the server 5 (step S25) and displays the information element map by using the received data (step S27). Incidentally, the processing progresses to the processing flow shown in FIG. 16 via a terminal B.

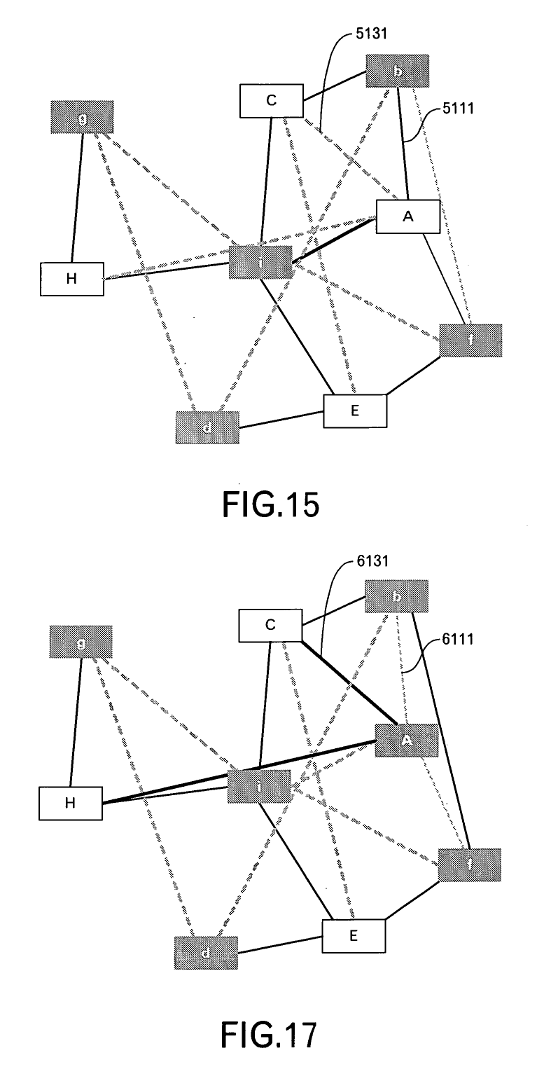

FIG. 15 shows an example of an information element map generated according to this embodiment of the present invention. While the example of FIG. 15 does not differ from the example of FIG. 5 in the arrangement of the information elements, it differs from the example of FIG. 5 in that a relational line 5111 between information elements belonging to different categories is represented by a black solid line and a relational line 5131 between information elements belonging to the same category is represented by a gray dashed line. Therefore, the user can easily understand the relations between the information elements belonging to different categories in comparison with the information element map shown in FIG. 5.

Subsequently, a processing carried out upon accepting the display change request from the user will be described by using FIG. 16. The display change request includes at least one of a category change request of an information element, an attribute change request of a relational line between information elements, and a rearrangement request of information elements, for example. The server 5 that received the display change request updates at least one of the category of the information element, the attribute of the relational line between the information elements, and the degree of relation between the information elements according to the request and then generates a new information element map using the updated information. Incidentally, the display change request may be accepted after the information element map is displayed on the user terminal, and a search condition including the display change request may be accepted as described above.

The user inputs the display change request as described above into the user terminal 3. Thereupon, the user terminal 3 accepts the input of the display change request from the user (step S51) and transmits the display change request to the server 5 (step S53). The data receiver 501 of the server 5 receives the display change request and stores it into the received data storage 503 (step S55).

Then, the category identifying unit 521 judges whether the stored display change request includes a category change request of the information element with reference to the received data storage 503 (step S57). When the display change request is determined to include the category change request of the information element (step S57: YES route), the category identifying unit 521 updates the category of the information element related to the request and stores it into the information element storage 515 (step S59). On the other hand, when the display change request does not include the category change request of the information element (step S57: NO route), the processing progresses to step S61. Here, an example is described where a request is made to change the category of, for example, the information element A belonging to the category “object” shown in FIG. 15 to the category “means.”

As described above, the information element A is “lightweighting” and the relational line between the information element A and the information element belonging to the category “means” is highlighted as indicated by a relational line 5111 in FIG. 15. In some cases, however, the category determined in the category determination processing may be inappropriate or the user may want to change the category of a certain information element to an arbitrary category. For example, the user may want to know what effect will be achieved as a result of “lightweighting.” In this case, the category of the information element A is changed to “means” and the information element map is rearranged, whereby the relational line between the information element A and the information element belonging to the category “object” is highlighted. Thereby, the user can understand the “object” of carrying out “lightweighting” more easily.

In addition, when updating the category of the information element, the category identifying unit 521 updates the display attribute of the information element according to the category change and the association degree calculator 531 further updates the attribute of the degree of association between the information elements or the attributes of the relational line according to the category change.

Moreover, the display attributes of a selected information element may be updated so as to be hidden, and the association degree calculator 531 may further update the attributes of the relational line between the information elements so as to hide the relational line related to the hidden information element.

Incidentally, in accepting the selection of the information element whose category is required to be changed from the user, it is possible to accept the selection of the information element on the information element map, for example, displayed on the display screen of the user terminal 3, or to accept an instruction of collectively selecting information elements conforming to a condition such as an information element belonging to a specific category or an information element including a specific character string.

FIG. 17 shows an example where the information element A belonging to the category “object” is updated so as to belong to the category “means” in the information element map shown in FIG. 15. In an example of FIG. 17, the display attribute of the information element A is changed to the display attribute of the information element belonging to the category “means.” Furthermore, the relational line between the information element C belonging to the category “object” and the information element A is highlighted as indicated by a relational line 6131, while the relational line between the information element A and the information element b belonging to the category “means,” which has been highlighted in FIG. 15, is indicated by a gray dashed line as shown by a relational line 6111. Thereby, when “lightweighting” is considered to be “means,” the user understands more easily that the association with the “object” of “mileage” is strong, for example. Similarly, the relational lines between the information element A and the information element f, H, or i are respectively updated, so as to facilitate the understanding of the associations between the information element A and the information element belonging to the category “object.”

Incidentally, while FIG. 17 shows the example of updating the category of the information element to an existing category, it is also possible to generate a new category and to allocate the new category to the information element specified in the category change request of the information element.

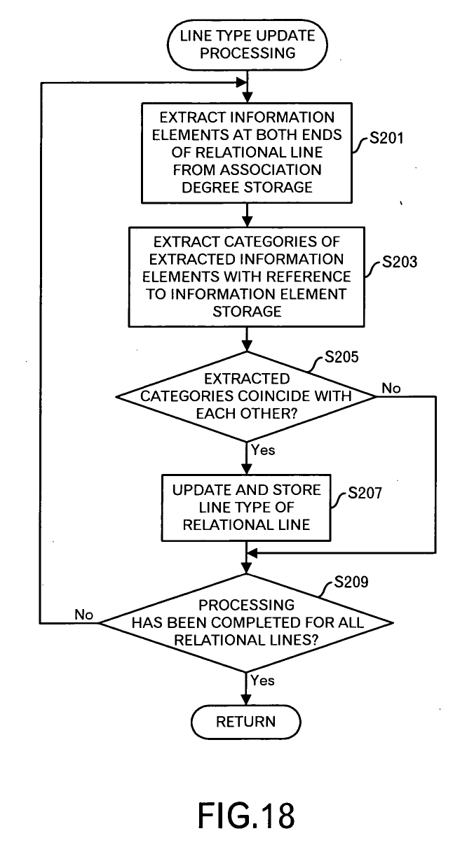

Subsequently, the association degree calculator 531 judges whether the stored display change request includes a line type change request of a relational line, namely an attribute change request of the relational line between the information elements with reference to the received data storage 503 (step S61). When the display change request is determined to include the line type change request (step S61: YES route), the line type update processing described later is carried out (step S63). On the other hand, when the display change request is not determined to include the line type change request (step S61: NO route), the processing progresses to step S65. Here, a case is described where a request is made to update the attributes of relational lines in such a way as to reduce the relational lines between information elements belonging to the same category, in other words, in such a way as to hide the relational lines, with reference to FIG. 18 to FIG. 20.

In FIG. 18, first, the association degree calculator 531 extracts the information elements at both ends of a relational line with reference to the association degree storage 533 (step S201). Subsequently, it extracts the categories of the information elements with reference to the information element storage 515 (step S203) and judges whether the categories of the information elements at both ends of the relational line are coincident with each other (step S205).

When the categories of the information elements are coincident with each other (step S205: YES route), the association degree calculator 531 updates the attribute of the relational line stored in the association degree storage 533 according to the line type change request of the relational line (step S207). Here, a processing of updating the color of the relational line to “transparent” or updating the line thickness to 0 is carried out to reduce the relational line. On the other hand, when the categories of the information elements are not coincident with each other, the processing progresses to step S209 (step S205: NO route).

Subsequently, the association degree calculator 531 judges whether the processing has been completed for all relational lines (step S209). Specifically, it judges whether the processing has been completed for all data stored in the association degree storage 533, for example. When there is a relational line that has not been processed yet, the processing returns to the step S201 to repeat the processing (step S209: NO route). When the processing is completed for all the relational lines, the processing returns to the original processing (step S209: YES route).

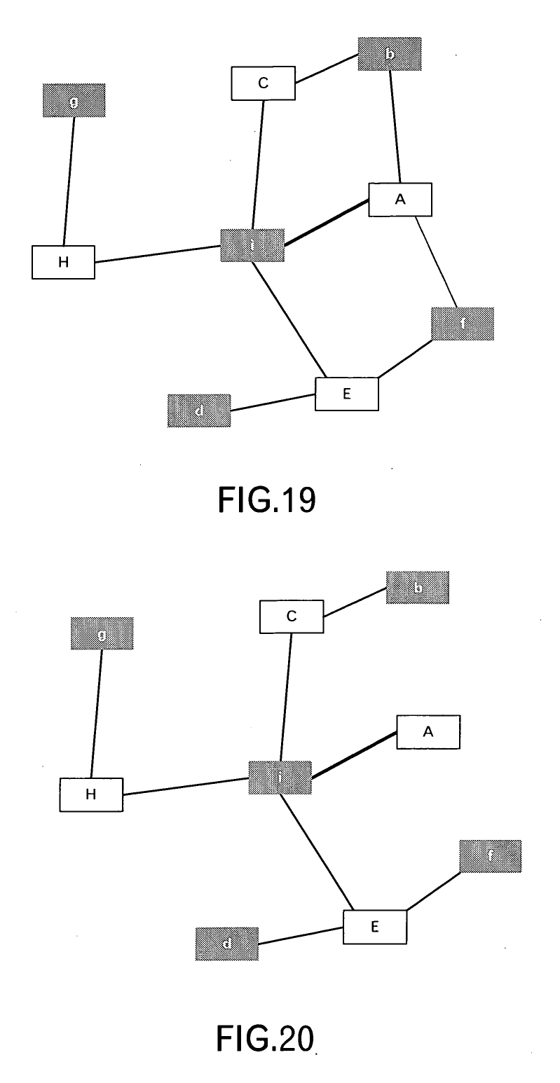

FIG. 19 shows a display example where relational lines between information elements belonging to the same category are reduced in the information element map shown in FIG. 15. As shown in FIG. 19, the relational lines between the information elements belonging to the same category are reduced. Therefore, it is effective to grasp only the associations of the relational lines between the information elements belonging to different categories.

Furthermore, in the line type update processing, further the attributes of the relational lines can be updated according to the difference in category and the degree of association in combination with the reduction of the relational lines in the conventional technique. FIG. 20 shows a display example where the relational lines between information elements whose degree of association is low are further reduced in the information element map shown in FIG. 19. Because the number of displayed relational lines is further reduced, the relations between information elements belonging to different categories can be understood more easily particularly when there are an extremely large number of information elements.

In addition, as a result of reducing relational lines, no relational line related to a certain information element may be display at all. In this case, the arrangement coordinate calculator 535 can update the display attribute of the information elements in such a way as to hide the information elements concerned. Alternatively, reducing may be carried out in such a way that the last relational line remains independently of the degree of association in order to prevent the situation where no relational line related to the information element is displayed at all.

Incidentally, for example, when the relational line is identified according to the degree of association, the degree of association between the information elements may also be updated in the line type update processing. For example, when the line update processing is carried out so as to thin a relational line, the degree of association may be decreased with thinning the relational line. Incidentally, the method of updating the degree of association between information elements will be described later. Unlike a coordinate update processing described later, the degree of association and the attribute of the relational lines between the information elements are updated in this processing, but the coordinates of the information elements are not updated. Therefore, the arrangement of the information elements in the information element map is not changed.

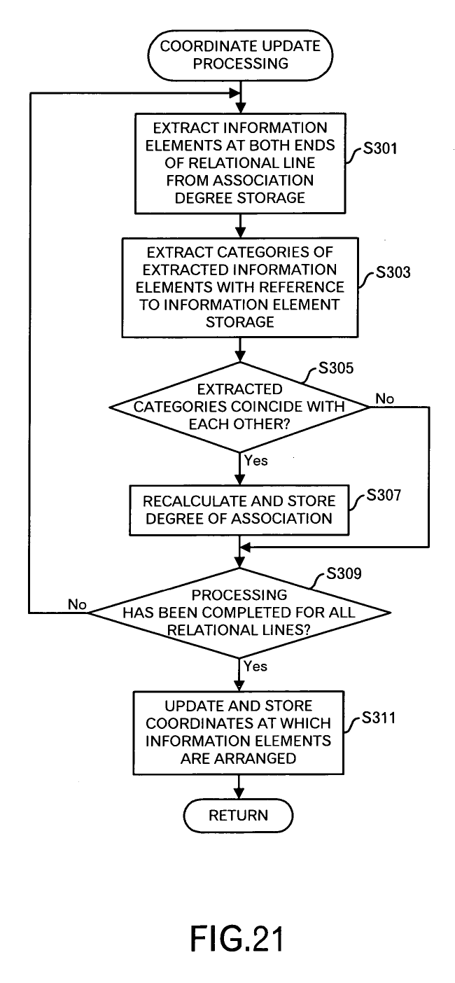

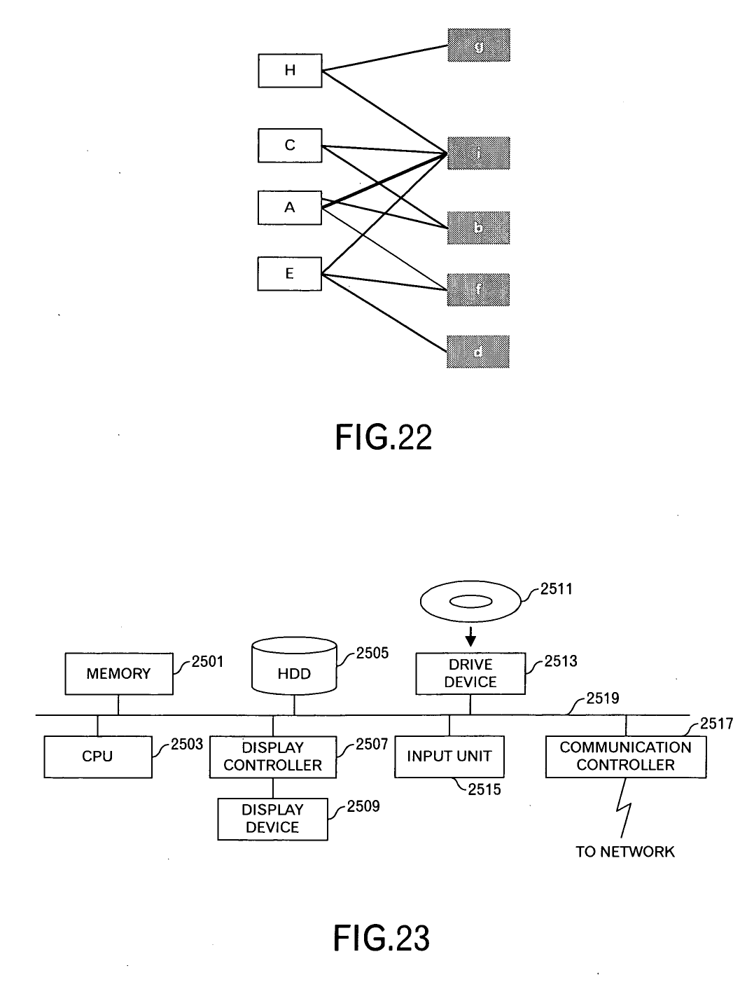

Subsequently, the association degree calculator 531 judges whether the stored display change request includes a rearrangement request of information elements with reference to the received data storage 503 (step S65). When the display change request is determined to include the rearrangement request of the information elements (step S65: YES route), the coordinate update processing described later is carried out (step S67). On the other hand, when the display change request is determined to include the rearrangement request of the information elements (step S65: NO route), the processing returns to the step S21 via a terminal E. Here, a case is described where a request has been accepted from the user that the user wants to rearrange the information elements in a mode in which the user can grasp only the associations between the information elements belonging to different categories, by using FIG. 21 and FIG. 22. More specifically, the following describes a case where the user makes a request for causing all of the associations between the information elements belonging to the same category to be 0.

In FIG. 21, the processings from step S301 to step S305 are the same as those of the line type update processing and therefore their descriptions are omitted here. It should be noted here, however, that the processing subject is the arrangement coordinate calculator 535. When the categories of the information elements are coincident with each other (step S305: YES route), the arrangement coordinate calculator 535 recalculates the degree of association stored in the association degree storage 533 according to the rearrangement request of the information elements and stores it into the association degree storage 533. (step S307). As a method of updating the degree of association, for example, the degree of association may be multiplied by a specific number, or the degree of association may be multiplied by itself. In this embodiment, the degree of association between the information elements belonging to the same category is multiplied by 0 in order to ignore the association between the information elements belonging to the same category. On the other hand, when the categories of the information elements are not coincident with each other, the processing progresses to step S309 (step S305: NO route).

Subsequently, the arrangement coordinate calculator 535 judges whether or not the processing is completed for all the relational lines (step S309). When there is any relational line that has not been processed yet, the processing returns to the step S301 to repeat the processing (step S309: NO route). On the other hand, when the processing is completed for all the relational lines (step S309: YES route), the arrangement coordinate calculator 535 recalculates the coordinates where the information elements are to be arranged according to the updated degree of association and stores them into the information element storage 515 (step S311).

FIG. 22 shows a display example where the degree of association between the information elements belonging to the same category is set to 0 in the information element map shown in FIG. 15. As shown in FIG. 22, the information elements are rearranged in a form where the degree of association between the information elements belonging to the same category is ignored. Therefore, the user can easily grasp the degree of association between the information elements belonging to different categories. In addition, the information elements themselves may be hidden and the relational lines related to the hidden information elements may be reduced similarly.

The coordinate update processing may also be combined with reducing association information in the conventional technique, whereby the associations between information elements whose degree of association can be reduced in the display. Due to a further decrease in the number of information elements and relational lines to be displayed, the user can easily understand the association between the information elements belonging to different categories particularly when the number of information elements is extremely large.

Incidentally, although the association between the information elements belonging to the same category is a target to be updated in the line type update processing and the coordinate update processing, the association between the information elements belonging to different categories may be a target to be updated.

As described hereinabove, according to this embodiment, it is possible to generate an information element map where the user can easily understand the association between the information elements belonging to different categories.

While the embodiment of the present invention have been described hereinabove, it is to be understood that the subject matter encompassed by the present invention is not limited to those specific embodiment. For example, the functional block diagram of the server 5 has been illustrated in FIG. 7, but it does not necessarily correspond to an actual program module configuration.

Moreover, the structure of the data stored in respective storages is not limited to the aforementioned examples, but a specific column may be separated from others as another table or a plurality of tables may be integrated into one table.

In addition, as well as the degree of association, the direction of association between information elements may be further included and the attribute of the relational line may be specified according to the direction of the association. This enables a generation of an information element map where the user can understand the cause-and-effect relationship, for example, between means and object or a time-series relationship more easily.

In addition, the user terminal 3 and the server 5 are computer devices as shown in FIG. 23. That is, a memory 2501 (storage device), a CPU 2503 (processor), a hard disk drive (HDD) 2505, a display controller 2507 connected to a display device 2509, a drive device 2513 for a removal disk 2511, an input device 2515, and a communication controller 2517 for connection with a network are connected through a bus 2519 as shown in FIG. 28. An operating system (OS) and an application program for carrying out the foregoing processing in the embodiment, are stored in the HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform necessary operations. Besides, intermediate processing data is stored in the memory 2501, and if necessary, it is stored in the HDD 2505. In this embodiment of this invention, the application program to realize the aforementioned functions is stored in the removal disk 2511 and distributed, and then it is installed into the HDD 2505 from the drive device 2513. It may be installed into the HDD 2505 via the network such as the Internet and the communication controller 2517. In the computer as stated above, the hardware such as the CPU 2503 and the memory 2501, the OS and the necessary application program are systematically cooperated with each other, so that various functions as described above in details are realized.

Although the present invention has been described with respect to a specific preferred embodiment thereof, various change and modifications may be suggested to one skilled in the art, and it is intended that the present invention encompass such changes and modifications as fall within the scope of the appended claims.

What is claimed is:

1. An information element processing program embodied on a medium, comprising:
extracting a plurality of information elements from an information group;
calculating a degree of each association between the extracted information elements;
identifying an attribute of a relational line connecting said extracted information elements to each other according to said degree of each said association between said extracted information elements;
identifying a category of each said extracted information element; and
updating at least one of said degree of said association between said extracted information elements and the identified attribute of said relational line according to the identified categories of said extracted information elements.

2. The information element processing program as set forth in claim 1, further comprising:
calculating coordinates at which said extracted information elements are arranged, according to said degree of said association between said extracted information elements.

3. The information element processing program as set forth in claim 2, wherein said calculating coordinates is executed when said degree of said association between said extracted information elements are updated in said updating.

4. The information element processing program as set forth in claim 2, further comprising:
generating data to display an association between said extracted information elements by using said degree of said association between said extracted information elements, said identified attribute of each said rational line, and said coordinate at which said extracted information elements are arranged.

5. The information element processing program as set forth in claim 1, further comprising:
obtaining information representing a correspondence between said extracted information element and said identified category.

6. The information element processing program as set forth in claim 1, further comprising:
identifying at least one of an appearance position of each said extracted information element and dependency information of each said extracted information element, and
wherein said identifying a category comprises: identifying a category of each said extracted information element according to at least one of an appearance position of each said extracted information element and dependency information of each said extracted information element.

7. The information element processing program as set forth in claim 1, wherein said identifying a category comprises identifying a category of each said extracted information element according to character string information included in each said extracted information element.

8. The information element processing program as set forth in claim 1, further comprising:
accepting a request for changing a category of an arbitrary information element among said plurality of extracted information elements, and
wherein said identifying a category comprises changing said category of said arbitrary information element according to said accepted request.

9. The information element processing program as set forth in claim 1, wherein said updating comprises judging according to said categories whether or not said association between said extracted information elements exists.

10. The information element processing program as set forth in claim 1, wherein said updating comprises setting a relational line to a non-display state according to said categories at both ends of said relational line.

11. The information element processing program as set forth in claim 1, further comprising:
updating display attributes of each said extracted information element.

12. The information element processing program as set forth in claim 11, wherein said updating display attributes comprises setting a specific information element and a relational line relating to said specific information element to a non-display state.

13. The information element processing program as set forth in claim 1, wherein said information group is a patent document group and said extracted information element is at least one of bibliographic information of said patent document group and words used in said patent document group.

14. An information element processing method, comprising:
extracting a plurality of information elements from an information group;
calculating a degree of each association between the extracted information elements;
identifying an attribute of a relational line connecting said extracted information elements to each other according to said degree of each said association between said extracted information elements;
identifying a category of each said extracted information element; and
updating at least one of said degree of said association between said extracted information elements and the identified attribute of said relational line according to the identified categories of said extracted information elements.

15. An information element processing apparatus, comprising:
a storage unit storing a plurality of information elements and a degree of each association between said information elements;
a unit that identifies an attribute of a relational line connecting said extracted information elements to each other according to said degree of each said association between said extracted information elements, and stores the identified attribute of said relational line into said storage unit;
a unit that identifies a category of each said extracted information element, and stores the identified category into said storage unit; and
a unit that updating at least one of said degree of said association between said extracted information elements and the identified attribute of said relational line according to the identified categories of said extracted information elements, and stores the updated data into said storage device.
